(19) United States
(12) Patent Application Publication
(10) Pub. No.: US 2002/0139770 A1
(43) Pub. Date: Oct. 3, 2002

(54) Methods for fabricating segmented reticle blanks having uniformly machined grillage, and reticle blanks and reticles formed thereby

(75) Inventor: Norihiro Katakura, Kawasaki-shi (JP)

Correspondence Address: KLARQUIST SPARKMAN, LLP, One World Trade Center, Suite 1600, 121 S.W. Salmon Street, Portland, OR, 97204-2988, US

(73) Assignee: Nikon Corporation

(21) Appl. No.: 10/086,682

(22) Filed: Feb. 28, 2002

(30) Foreign Application Priority Data
Apr. 3, 2001 (JP) 2001-104439

(51) Int. Cl. B44C 1/22

(52) U.S. Cl. 216/52

(57) ABSTRACT

Methods are disclosed for manufacturing segmented reticle blanks for use in fabricating segmented reticles for charged-particle-beam (e.g., electron beam) microlithography. The reticle blank includes a grillage of support struts having a substantially uniform depth and width throughout the reticle blank. A reticle substrate is prepared from a silicon substrate wafer. Beginning on a second major surface of the wafer, discharge-machining is performed part way into the thickness dimension of the silicon substrate so as to form from the silicon substrate a grillage of intersecting struts separating respective subfield regions from one another. In regions not occupied by respective struts, further machining into the thickness dimension is performed by dry-etching until each subfield region includes a respective membrane formed by a residual portion of the reticle substrate extending into the thickness dimension from the first major surface.

### FIELD

This disclosure pertains to microlithography (transfer-exposure of a pattern from a reticle to a substrate). Microlithography is a key technique used in the manufacture of microelectronic devices such as integrated circuits, displays, thin-film magnetic pickup heads, and micromachines. More specifically, the disclosure pertains to stencil reticles for use in microlithography performed using a charged particle beam, and to methods for fabricating such reticles.

### BACKGROUND

Most conventional microlithography technology remains “optical” in nature, chiefly utilizing deep UV wavelengths of light. Even though optical microlithography has been developed to exhibit extremely high performance, optical microlithography has limits with respect to the maximum achievable resolution of the transferred pattern. Meanwhile, there has been a relentless increase in the integration of active circuit elements in microelectronic devices, which has urged the development of “next-generation” microlithography systems that use an energy beam other than deep UV light to achieve substantially finer resolution than obtainable using optical microlithography. Promising candidate next-generation microlithography technologies utilize a charged particle beam (e.g., electron beam or ion beam) or an X-ray beam as the lithographic energy beam. Certain of these next-generation technologies are on the threshold of being “practical.”

As noted above, an exemplary charged-particle-beam (CPB) microlithography apparatus utilizes an electron beam. It now is possible to focus an electron beam to a diameter of a few nanometers. Such a narrow beam advantageously can form pattern features, as projected onto a lithographic substrate, of 0.1 μm or smaller.

Certain conventional electron-beam lithographic exposure systems utilize an electron beam to draw patterns feature-by-feature. With such a system, the finer the pattern, the narrower the beam must be, and the longer the time necessary to draw the pattern. With these systems, low throughput is a major problem.

Consequently, much development effort currently is being expended to provide a practical CPB microlithography system that utilizes a “divided” or “segmented” reticle. A divided reticle defines an entire pattern to be transferred to a substrate, but the pattern as defined on the reticle is divided into a large number of portions (termed “subfields”) each defining a respective portion of the pattern. Typically, each subfield as projected onto the substrate is dimensioned approximately 200-250 μm on each side (wherein a 250-μm square subfield on the substrate is about the largest that can be exposed currently without significant aberration). Since projection normally is performed with demagnification (e.g., ⅕), each subfield is dimensioned approximately 1 mm per side on the reticle.

A representative portion of such a reticle 1 is shown in FIGS. 3(a)-3(b), in which FIG. 3(b) is an oblique perspective view, and FIG. 3(a) is an elevational section along the line A-A. A number of individual subfields SF are shown. In each subfield SF the respective pattern portion is defined in a respective portion of the reticle membrane M. The surface 6 represents a “first major surface” of the reticle 1. Individual subfields SF are separated from one another by intersecting “struts” 2 that collectively form a lattice-like “grillage” conferring substantial structural strength and rigidity to the reticle 1. The edges of the struts 2 collectively define a plane 5 that is parallel to the plane defined by the membrane M. The plane 5 represents a “second major surface” of the reticle 1. The depicted reticle 1 is a “stencil” reticle in which pattern features are defined as corresponding CPB-transmissive through-holes (apertures) 3 in the relatively CPB-scattering reticle membrane M. The membrane M typically is about 2 μm thick. It will be appreciated that a typical divided reticle 1 comprises a large number (typically many thousands) of subfields SF.

The reticle 1 is fabricated conventionally by the following method. A silicon wafer is prepared having parallel major surfaces that are (100) crystal surfaces. A first major surface of a silicon (Si) wafer is boron-doped to a predetermined depth (and boron concentration, usually 1×10²⁰ atoms/cm³) in the thickness dimension of the wafer. The opposing second major surface of the wafer is patterned and masked (with, e.g., silicon nitride) to define the arrangement of the struts 2 (i.e., regions to be occupied by the struts 2 are masked and other regions are left “exposed” to an etchant). The bulk of silicon situated between the first and second major surfaces is termed the “silicon substrate.” The “exposed” silicon substrate on the second major surface of the wafer is anisotropically wet-etched, from the second major surface into the thickness dimension of the silicon substrate, using an aqueous potassium hydroxide etchant solution. Etching stops when the etchant has penetrated through the silicon substrate to the boron-doped layer, thereby leaving the boron-doped layer as the membrane M. Thus, a “reticle blank” is made. Next, a resist or the like is applied to the boron-doped first major surface of the wafer. The resist is imaged with the desired reticle pattern using an electron-beam drawing apparatus. Using the resulting resist pattern as a mask, the reticle membrane M is etched to form the through-holes 3 corresponding to the respective pattern elements, thereby completing formation of the stencil reticle 1.

In the method described above, the wet-etching is anisotropic according to the crystal plane being etched. Consequently, the struts 2 are formed having side-walls sloped at an angle of 54.74° relative to the plane of the membrane M. These sloped side-walls collectively occupy much space on the reticle, which requires that a reticle defining an entire pattern be very large. Unfortunately, the larger the reticle, the more fragile and more difficult it is to handle and use. Hence, alternative reticle-fabrication methods have been proposed that effectively provide the struts 2 with steeper side-walls and thus a thinner transverse section. These alternative methods employ dry-etching to form the struts.

An exemplary alternative conventional method is depicted in FIGS. 4(a)-4(c). In the first step, a first major surface of a silicon wafer 14 is doped with boron to form a boron-doped layer 13 (FIG. 4(a)). In a second step, a strut-defining mask 15 (silicon oxide) is applied to the second major surface. The bulk silicon between the first and second major surfaces is the “silicon substrate.” The “exposed” silicon on the second major surface is dry-etched into the thickness dimension of the silicon substrate toward the boron-doped layer 13 until a few tens of μm (e.g., 20 to 30 μm) of undoped silicon substrate 16 are left, thereby forming most of the struts 12 (FIG. 4(b)) from the silicon substrate. Next, anisotropic wet-etching is performed to etch away the remaining undoped silicon substrate 16. Wet-etching stops at the boron-doped layer 13, leaving a reticle membrane M having a specified thickness. Note that the wet-etching leaves sloped “feet” on the struts 12. After removing residual material of the mask 15, formation of the reticle blank is complete (FIG. 4(c)). Subsequent patterning of the membrane M completes fabrication of a reticle.

A simplified version of the method of FIGS. 4(a)-4(c) begins with an SOI (Silicon-On-Insulator) wafer as shown in FIG. 5(a). The SOI wafer includes a silicon oxide layer 17 formed on a silicon substrate 18. A thin silicon layer 19 is formed superposedly on the oxide layer 17. The silicon oxide layer 17 can be used as an etch-stop layer for dry-etching. Thus, beginning with a masked SOI wafer, a reticle blank can be fabricated comprising struts having perpendicular (maximally steep) side walls and individual transverse widths of a few hundred μm. The struts are formed by dry-etching the silicon substrate 18.

FIGS. 5(a)-5(c) are sectional views of the results of respective steps in a method for fabricating a reticle blank beginning with an SOI wafer. First, as shown in FIG. 5(a), an SOI wafer is prepared as described above. Next, as shown in FIG. 5(b), a durable resist or silicon oxide layer 20 is applied to the “lower” (in the figure) surface of the silicon substrate 18. The resist layer 20 is patterned to mask regions corresponding to the intended locations of the struts 22a-22c (FIG. 5(c)). Next, the silicon substrate 18 is dry-etched according to the mask pattern, with the silicon oxide layer 17 serving as an etch-stop layer. The resulting struts 22a-22c have maximally steep side-walls and are typically a few hundred μm wide in the transverse direction. Next, the exposed silicon oxide layer 17 is etched away (using, e.g., hydrofluoric acid). Removing the residual mask 20 completes fabrication of the reticle blank (FIG. 5(c)).

In both methods described above, etching must be performed to a depth substantially equal to the thickness of the silicon wafer (or silicon substrate). The wafer thickness depends upon wafer diameter. For example, with a 3-inch diameter wafer, the etching depth is approximately 380 μm; with an 8-inch diameter wafer, the etching depth is approximately 725 μm. FIG. 6 depicts an exemplary reticle blank 25 fabricated from an 8-inch diameter wafer. The reticle blank 25 defines two 132 mm×55 mm pattern-defining zones 26a, 26b each comprising a large number of subfields separated from each other by struts, as described above. The zones 26a, 26b are separated from each other by an intervening wide strut 27.

Conventionally, dry-etching to depths of hundreds of μm (e.g., 700 μm or greater) are performed with side-wall protection to ensure accurate unidirectional etching. I.e., for suppressing etching in the lateral direction (e.g., into the side-walls of struts being formed by the etching), the dry-etching is performed in the presence of a polymer-forming gas. As etching proceeds in the thickness dimension of the wafer, the polymer-forming gas reacts to form molecules of the polymer that deposit on the side-walls and protect the side-walls from the etching gas. Thus, the regions between the struts are etched away depthwise while providing the resulting struts with side-walls having good perpendicularity relative to the membrane.

Whenever a reticle blank is fabricated from a large-diameter wafer (e.g., 8 inches in diameter or more), differential etching rates are observed in the center of the wafer versus the periphery of the wafer, due to a “loading effect.” For example, as shown in FIG. 6, two 132 mm×55 mm pattern-defining zones 26a, 26b are formed in an 8-inch diameter reticle blank 25. Each zone 26a, 26b represents a very large area that must undergo substantial etching in order to define the membrane regions and struts in the respective zone. These zones 26a, 26b are so large that substantial differences in etching rate, versus position within the zones, are exhibited. In some cases the etching rate at the periphery of a zone is nearly double the rate at the center of the zone.

Whenever non-uniform etching rates occur in this manner, the wafer must be exposed to etching conditions for an excessive amount of time (for the rapidly etched areas) in order to ensure adequate etching of the slowly etched areas. As a result, the struts in the rapidly etched areas become too narrow for providing adequate physical support for the reticle.

### SUMMARY

In view of the disadvantages of conventional methods as summarized above, the invention provides, inter alia, methods for fabricating segmented stencil reticle blanks (and reticles therefrom) in which the struts have uniform thickness and depth throughout the reticle.

To such end and according to a first aspect of the invention, methods are disclosed for manufacturing a reticle blank usable for fabricating a segmented reticle for use in charged-particle-beam microlithography. In an embodiment of such a method, a reticle substrate is prepared from a silicon wafer (silicon substrate). The reticle substrate has first and second major surfaces. Beginning on the second major surface, discharge-machining is performed part way into the thickness dimension of the silicon substrate toward the first major surface so as to form from the silicon substrate a grillage of intersecting struts separating respective subfield regions from one another. After completion of discharge-machining, dry-etching is performed (in regions not occupied by respective struts) further into the thickness dimension of the silicon substrate toward the first major surface until each subfield region includes a respective membrane formed by a residual portion of the reticle substrate extending into the thickness dimension from the first major surface.

In the foregoing method, the grillage is formed by a combination of the discharge-machining step, which forms a substantial portion of the grillage into the thickness dimension of the reticle substrate, and the subsequent dry-etching step, which completes formation of the grillage and intervening membrane structure in the subfield regions. By forming substantial portions of the grillage initially by discharge-machining, the grillage is formed with better uniformity than by dry-etching. Hence, dry-etching desirably is relegated to a “finish-up ” role after the discharge-machining step, thereby minimizing the effects of process non-uniformity characteristic of dry-etching. The overall advantage of methods according to the invention is substantial uniformity of the struts in the thickness dimension of the reticle substrate, as well as substantial uniformity of strut width over the entire reticle blank. The reason that discharge-machining is not performed to the full extent through the thickness dimension (and that “finish-up” machining by dry-etching is used) is that achieving an accurate and precise halt to discharge-machining is difficult. Hence, discharge-machining is performed desirably until only a relatively small amount of the silicon substrate remains left in the thickness dimension.

The discharge-machining step desirably is performed using a discharge-machining electrode placed, at initiation of discharge-machining, adjacent the second major surface and separated therefrom by a discharge gap. The discharge-machining electrode desirably comprises a facing surface in which are defined grooves that correspond in respective dimensions, positions, and arrangement to desired respective dimensions, positions, and arrangement of the struts. Thus, between the grooves are projections that correspond in respective dimensions, positions, and arrangement to desired respective dimensions, positions, and arrangement of the subfield regions. Each groove desirably has a width equal to two times the discharge gap, plus a desired width of the corresponding strut to be formed by the groove.

The reticle blank is formed to have at least one pattern-defining zone. In view of the typically relatively large size of the pattern-defining zone, the discharge-machining electrode desirably has an area that is smaller, by an integer ratio, than the pattern-defining zone.

The step of preparing a reticle substrate can comprise preparing a silicon-on-insulator (SOI) wafer substrate, comprising a silicon oxide layer and a silicon layer on the first major surface. The silicon oxide layer desirably is formulated to be an etch-stop layer, wherein dry-etching is continued through the thickness dimension to the etch-stop layer.

The SOI wafer substrate can include a metal layer (e.g., chromium, nickel) on the second major surface. With such a wafer substrate, the discharge-machining step is initiated by placing the discharge-machining electrode adjacent the metal layer and separated therefrom by a discharge gap. The metal layer is useful, during a later step involving removal of “exposed” portions of the silicon oxide layer, as a mask, as noted below.

In another embodiment of the method, a reticle substrate is prepared from an SOI wafer comprising a relatively thick layer of silicon substrate having first and second major surfaces. The silicon substrate includes a relatively thin silicon oxide layer on the first major surface and a relatively thin silicon layer superposed on the silicon oxide layer, and a relatively thin metal layer (e.g., chromium or nickel) on the second major surface. Beginning at the metal layer on the second major surface, discharge-machining is performed into the silicon substrate toward the first major surface through most of the thickness dimension so as to form from the silicon substrate a grillage of intersecting struts separating respective subfield regions from one another. In regions not occupied by respective struts, dry-etching is performed further through the thickness dimension of the silicon substrate to the silicon oxide layer, serving as an etch-stop layer, so as to provide each subfield region with a respective membrane formed by the silicon oxide layer and relatively thin silicon layer. Finally, exposed portions of the silicon oxide layer are removed (e.g., by etching), using the remaining portions of the metal layer as an etching mask.

The discharge-machining step desirably is performed using a discharge-machining electrode placed, at initiation of discharge-machining, adjacent the metal layer and separated therefrom by a discharge gap. As noted above, the discharge-machining electrode desirably comprises a facing surface in which are defined grooves that correspond in respective dimensions, positions, and arrangement to desired respective dimensions, positions, and arrangement of the struts. Between the grooves are projections that correspond in respective dimensions, positions, and arrangement to desired respective dimensions, positions, and arrangement of the subfield regions.

According to another aspect of the invention, reticle blanks are provided that are manufactured by a method as summarized above.

Also provided are methods for fabricating a segmented reticle for use in charged-particle-beam microlithography. An exemplary embodiment includes fabricating a reticle blank using a method such as summarized above. A layer of resist is formed on the first major surface of the reticle blank, wherein the layer of resist is patterned according to a desired reticle pattern. Using the patterned resist as a mask, elements of the pattern are formed on the reticle blank, e.g., by a suitable etching step.

According to another aspect of the invention, reticles are provided that are fabricated by a method such as summarized above.

The foregoing and additional features and advantages of the invention will be more readily apparent from the following detailed description, which proceeds with reference to the accompanying drawings.

### BRIEF DESCRIPTION OF THE DRAWINGS

FIGS. 1(a)-1(d) are elevational sections of a portion of a silicon-on-insulator (SOI) wafer made into a reticle blank by a representative embodiment of a method according to the invention. Each figure depicts the result of a respective step in the method.

FIG. 2 is an oblique view of a discharge-machining electrode used in the method shown in FIGS. 1(a)-1(d).

FIG. 3(a) is an elevational section (along the line A-A in FIG. 3(b)) of a portion of a conventional segmented stencil reticle as used for performing charged-particle-beam (CPB) microlithography.

FIG. 3(b) is an oblique perspective view of the portion of a segmented reticle shown in FIG. 3(a), depicting multiple subfields separated from each other by a grillage of struts, and each subfield having a respective portion of the reticle membrane defining a respective portion of the reticle pattern.

FIGS. 4(a)-4(c) are elevational sections showing the results of respective steps in a first conventional method for fabricating a reticle blank used for fabricating a stencil reticle for use in CPB microlithography.

FIGS. 5(a)-5(c) are elevational sections showing the results of respective steps in a second conventional method for fabricating a reticle blank, starting with an SOI wafer (FIG. 5(a)).

FIG. 6 is a plan view of a segmented reticle made from a reticle blank fabricated from an 8-inch diameter wafer.

### DETAILED DESCRIPTION

The following description is set forth in the context of a representative embodiment that is not intended to be limiting in any way.

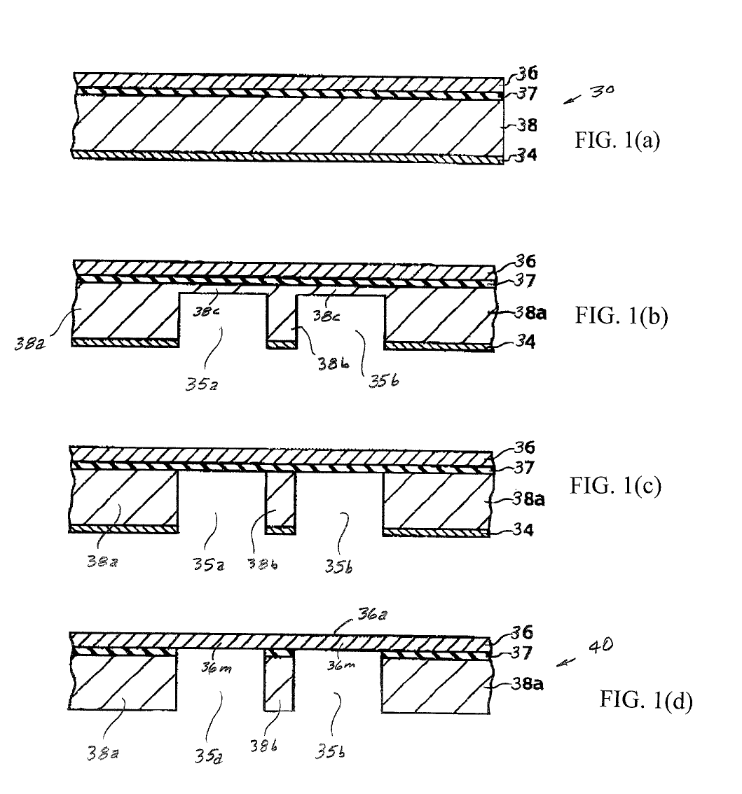

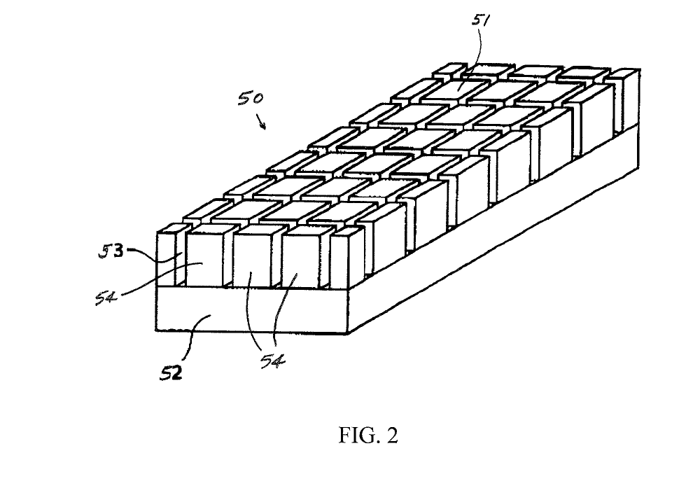

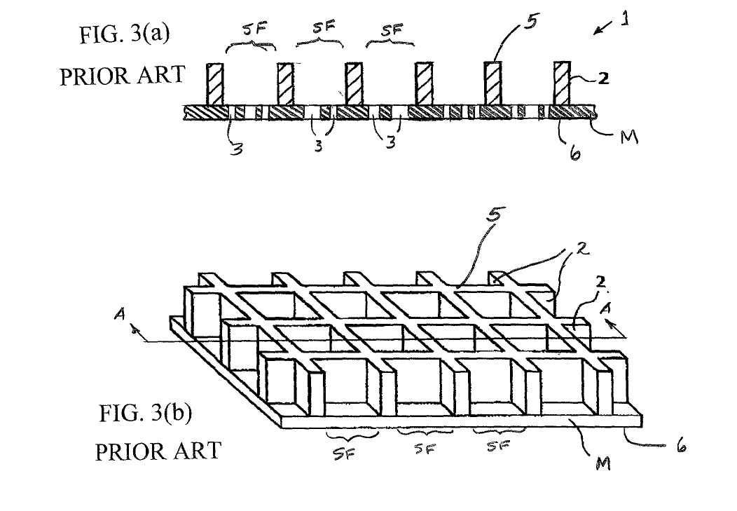

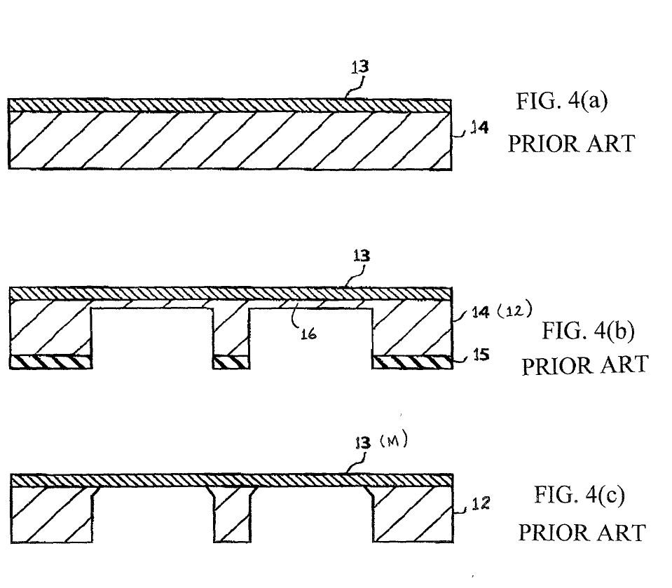

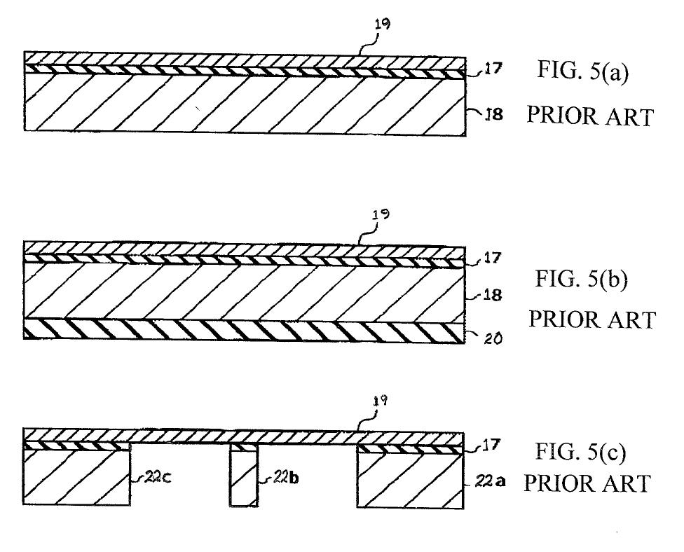

A method, according to a representative embodiment, for fabricating a stencil reticle blank for use in forming a stencil reticle for electron-beam microlithography (as an exemplary charged-particle-beam microlithography) is depicted in FIGS. 1(a)-1(d). FIGS. 1(a)-1(d) show, in elevational sections, the results of respective steps in the method. A discharge-machining electrode used in making the reticle blank is shown obliquely in FIG. 2.

In a first step of the method a silicon-on-insulator (“SOI”) wafer 30 is produced, comprising a silicon substrate 38, a thin silicon oxide insulating layer 37 formed on a first major surface of the silicon substrate 38, and a thin silicon layer 36 superposed on the silicon oxide layer 37. By way of example, this SOI wafer 30 has a diameter of eight inches and a thickness of 725 μm. Next, a thin layer 34 of conductive metal (e.g., chromium, about 0.2 μm thick) is formed on a second major surface (opposite the first major surface) of the silicon substrate 38.

In a subsequent step, portions of the metal layer 34 and underlying silicon substrate 38 are selectively removed so as to form spaces, between struts formed by remaining silicon substrate, corresponding to the locations of intended subfields in the reticle. This selective removal is performed largely by electric discharge-machining.

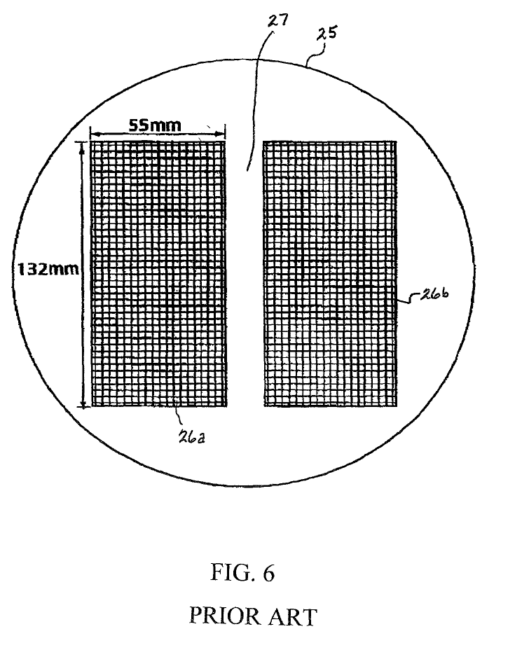

Discharge-machining is performed using a discharge-machining electrode 50 (FIG. 2) desirably made of copper or aluminum and having a planar “facing surface” 51. The facing surface 51 defines grooves 53 that correspond in respective dimensions (see below), positions, and arrangement to the desired respective dimensions, positions, and arrangement of the struts to be formed thereby in the SOI wafer 30. Between the grooves 53 are projections 54 that correspond in respective dimensions, positions, and arrangement to the desired respective dimensions, positions, and arrangement of subfields to be formed in the SOI wafer. The electrode 50 also has a base 52. The discharge electrode 50 is sized such that the area encompassed by the facing surface 51 and grooves 53 is equal to or less than the area of the patten-defining zones (regions 26a, 26b in FIG. 6). To limit the size of the electrode 50, the area of the electrode 50 desirably is an integer fraction (e.g., ⅛) of the area of the pattern-defining zones.

During discharge-machining, the electrode 50 is placed relative to the workpiece such that the facing surface 51 is separated from the workpiece by the required small “discharge gap.” To ensure, after completion of discharge-machining, that the struts formed thereby have a specified width, each groove 53 in the facing surface 51 of the electrode 50 desirably has a width equal to twice the discharge gap plus the desired width of the respective strut to be formed by the groove 53.

To begin discharge-machining, the facing surface 51 of the electrode 50 is placed adjacent the metal layer 34 (separated by the “discharge gap”) while the SOI wafer 30 and electrode 50 are immersed in an insulator liquid. The electrode 50 is connected to a negative voltage and the silicon substrate 38 is connected to a positive voltage (typical voltage difference is about 30 V). Upon application of the respective voltages to the electrode 50 and silicon substrate 38, electric discharge-machining is initiated at the surface of the metal layer 34 at the regions of electric discharge between the surface 51 and the metal layer 34.

As discharge-machining progresses (according to the configuration of the projections 54) through the metal layer 34 into the thickness dimension of the silicon substrate 38, the electrode 50 is moved toward the SOI wafer 30. This results in the projections 54 becoming inserted into the corresponding voids 35a, 35b formed in the silicon substrate 38. Discharge-machining is continued until it has progressed nearly through the thickness dimension of the silicon substrate 38, thereby forming the structure shown in FIG. 1(b). In FIG. 1(b) the remaining regions of the silicon substrate 38 define the struts (which can be wide struts 38a or narrow struts 38b, respectively, as required). The voids 35a, 35b correspond to respective projections 54 of the discharge electrode 50.

At conclusion of discharge-machining a small amount of the silicon substrate 38c (about 45 μm thick, for example) is deliberately left at the “bottom” of the hollowed-out regions 35a, 35b. (Thus, in this example, the discharge-machining is performed to a depth of about 680 μm.) With an 8-inch diameter SOI wafer, if a single discharge-machining step processes one-eighth of the pattern-defining portion of the reticle blank, then discharge-machining is repeated seven more times to complete formation of the struts in the entire pattern-defining region of the reticle blank.

Next, the machined SOI wafer is rinsed. The remaining silicon substrate 38c is removed by dry etching, using the remaining metal layer 34 as an etching mask (FIG. 1(c)). The intermediate silicon oxide layer 37 serves as an etch-stop layer.

Finally, the remaining metal layer 34 is removed, and the “exposed” silicon oxide layer 37 is removed by using mixed solution of hydrofluoric acid and ammonium fluoride. This completes formation of the reticle blank 40 (FIG. 1(d)), comprising membrane portions 36m and supporting struts 38a, 38b.

To form a stencil reticle from the reticle blank 40, a film of resist is applied to the surface 36a of the membrane 36m. The resist is lithographically exposed to define a desired reticle pattern on the surface 36a, wherein the resist pattern defines the respective locations of pattern-element-defining stencil apertures to be formed in the membrane 36m. The resulting masked reticle blank is dry-etched, according to the mask pattern, to form the reticle.

Removing most of the thickness dimension of the silicon substrate 38 by discharge-machining as described above can be performed with much better uniformity than by dry-etching. Even though the remaining silicon substrate 38c is removed by dry-etching, the relative amount of silicon substrate removed by dry-etching is small; also, the silicon oxide layer 37 is an effective etch-stop. By substantially increasing process uniformity across the surface of the SOI wafer in this manner, the deleterious effects of non-uniform processing (according to conventional methods) are avoided. Consequently, the geometry of the struts 38a, 38b and the depth of the voids 35a, 35b are substantially uniform across the entire reticle blank.

In this embodiment, discharge-machining performs machining through most of the desired depth in the silicon substrate 38, leaving only “finish-up” machining to the desired depth being performed by dry-etching. Using dry-etching only for a “finish-up” machining step substantially improves the ease and reliability with which dry-etching can be controllably stopped at the silicon oxide layer 37. Also, compared to conventional methods in which all the machining of the struts and subfield regions is performed by dry-etching, discharge-machining followed by “finish-up” dry-etching as performed in the instant embodiment yields a more consistent and uniform depth of machining over the entire wafer.

Various modifications to the specific representative embodiment described above are envisioned. For example, whereas the described embodiment utilized a discharge-machining electrode 50 having an area of one-eighth the total intended pattern-defining area of the reticle blank, this area factor is not intended to be limiting. Other ratios of the area of the electrode relative to the pattern-defining area are possible. It is also possible to use a discharge-machining electrode having another overall configuration besides rectangular.

As another example modification, whereas the method embodiment described above began with an SOI wafer, it will be understood that the method can begin with, for example, a silicon wafer having a doped first major surface.

Whereas the invention has been described in connection with a preferred embodiment, it will be understood that the invention is not limited to that embodiment. On the contrary, the invention is intended to encompass all modifications, alternatives, and equivalents as may be included within the spirit and scope of the invention, as defined by the appended claims.

What is claimed is:

1. A method for manufacturing a reticle blank usable for fabricating a segmented reticle for use in charged-particle-beam microlithography, the method comprising:
preparing a reticle substrate comprising a silicon substrate, the reticle substrate having first and second major surfaces;
beginning on the second major surface, discharge-machining part way into a thickness dimension of the silicon substrate toward the first major surface so as to form from the silicon substrate a grillage of intersecting struts separating respective subfield regions from one another; and
in regions not occupied by respective struts, dry-etching further into the thickness dimension of the silicon substrate toward the first major surface until each subfield region includes a respective membrane formed by a residual portion of the reticle substrate extending into the thickness dimension from the first major surface.

2. The method of claim 1, wherein the discharge-machining step is performed using a discharge-machining electrode placed, at initiation of discharge-machining, adjacent the second major surface and separated therefrom by a discharge gap.

3. The method of claim 2, wherein:
the discharge-machining electrode comprises a facing surface in which are defined grooves that correspond in respective dimensions, positions, and arrangement to desired respective dimensions, positions, and arrangement of the struts; and
between the grooves are projections that correspond in respective dimensions, positions, and arrangement to desired respective dimensions, positions, and arrangement of the subfield regions.

4. The method of claim 3, wherein:
the reticle blank is formed to have a pattern-defining zone having an area; and
the discharge-machining electrode has an area that is smaller, by an integer ratio, than the pattern-defining zone.

5. The method of claim 3, wherein each groove has a width equal to two times the discharge gap, plus a desired width of the corresponding strut to be formed by the groove.

6. The method of claim 1, wherein the step of preparing a reticle substrate comprises preparing a silicon-on-insulator (SOI) wafer substrate, comprising a silicon oxide layer and a silicon layer on the first major surface.

7. The method of claim 6, wherein the silicon oxide layer is formulated to be an etch-stop layer.

8. The method of claim 6, wherein dry-etching is continued through the thickness dimension to the etch-stop layer.

9. The method of claim 6, wherein the step of preparing a reticle substrate comprises forming a metal layer on the second major surface.

10. The method of claim 9, wherein the discharge-machining step is performed using a discharge-machining electrode placed adjacent the metal layer and separated therefrom by a discharge gap.

11. The method of claim 10, wherein:
the discharge-machining electrode having a facing surface in which are defined grooves that correspond in respective dimensions, positions, and arrangement to desired respective dimensions, positions, and arrangement of the struts; and
between the grooves are projections that correspond in respective dimensions, positions, and arrangement to desired respective dimensions, positions, and arrangement of the subfield regions.

12. The method of claim 9, wherein dry-etching is performed using remaining portions of the metal layer as an etching mask.

13. A reticle blank manufactured by a method as recited in claim 1.

14. A method for fabricating a segmented reticle for use in charged-particle-beam microlithography, comprising:
fabricating a reticle blank using a method as recited in claim 1;
forming a layer of resist on the first major surface of the reticle blank, the layer of resist being patterned according to a desired reticle pattern; and
using the patterned resist as a mask, forming elements of the pattern on the reticle blank.

15. A reticle fabricated by a method as recited in claim 14.

16. A method for manufacturing a reticle blank usable for fabricating a segmented reticle for use in charged-particle-beam microlithography, the method comprising:
preparing a reticle substrate from an SOI wafer comprising a relatively thick silicon substrate layer having first and second major surfaces, the silicon substrate having a thickness dimension and including a relatively thin silicon oxide layer on the first major surface and a relatively thin silicon layer superposed on the silicon oxide layer, and a relatively thin metal layer on the second major surface;
beginning at the metal layer on the second major surface, discharge-machining into the silicon substrate toward the first major surface through most of the thickness dimension so as to form from the silicon substrate a grillage of intersecting struts separating respective subfield regions from one another;
in regions not occupied by respective struts, dry-etching further through the thickness dimension of the silicon substrate to the silicon oxide layer, serving as an etch-stop layer, so as to provide each subfield region with a respective membrane formed by the silicon oxide layer and relatively thin silicon layer; and
removing exposed portions of the silicon oxide layer.

17. The method of claim 16, wherein the discharge-machining step is performed using a discharge-machining electrode placed, at initiation of discharge-machining, adjacent the metal layer and separated therefrom by a discharge gap.

18. The method of claim 17, wherein:
the discharge-machining electrode comprises a facing surface in which are defined grooves that correspond in respective dimensions, positions, and arrangement to desired respective dimensions, positions, and arrangement of the struts; and
between the grooves are projections that correspond in respective dimensions, positions, and arrangement to desired respective dimensions, positions, and arrangement of the subfield regions.

19. The method of claim 17, wherein dry-etching is performed using remaining portions of the metal layer as an etching mask.

20. A reticle blank manufactured by a method as recited in claim 16.

21. A method for fabricating a segmented reticle for use in charged-particle-beam microlithography, comprising:
fabricating a reticle blank using a method as recited in claim 16;
forming a layer of resist on the first major surface of the reticle blank, the layer of resist being patterned according to a desired reticle pattern; and
using the patterned resist as a mask, forming elements of the pattern on the reticle blank.

22. A reticle fabricated by a method as recited in claim 21.
